(19) United States
(12) Patent Application Publication
(10) Pub. No.: US 2009/0219901 A1
(43) Pub. Date: Sep. 3, 2009

(54) Wireless Content Aquisition for Mobile Electronic Devices

(76) Inventors: William E. Bull, Mountain View, CA (US); Policarpo Wood, San Francisco, CA (US); Kourtny Minh Hicks, Sunnyvale, CA (US)

Correspondence Address: TECHNOLOGY & INNOVATION LAW GROUP, PC, ATTN: 101, 19200 STEVENS CREEK BLVD., SUITE 240, CUPERTINO, CA, 95014, US

(21) Appl. No.: 12/167,148

(22) Filed: Jul. 2, 2008

Related U.S. Application Data
(60) Provisional application No. 61/032,867, filed on Feb. 29, 2008.

(51) Int. Cl. H04Q 7/20

(52) U.S. Cl. 370/338; 455/456.2

(57) ABSTRACT

Improved methods, computer readable media and systems that facilitate data acquisition by mobile electronic devices are disclosed. One aspect pertains to content acquisition between mobile electronic devices that are within range of a local wireless network. Another aspect pertains to content acquisition by mobile electronic devices capable of communicating across a peer-to-peer wireless network.

### CROSS-REFERENCE TO RELATED APPLICATION

This application claims priority to U.S. Provisional Patent Application No. 61/032,867, filed Feb. 29, 2008, entitled “WIRELESS CONTENT ACQUISITION FOR MOBILE ELECTRONIC DEVICES”, which is herein incorporated by reference.

### BACKGROUND OF THE INVENTION

1. Field of the Invention

The present invention relates to mobile electronic devices and, more particularly, to wireless content acquisition for mobile electronic devices.

2. Description of the Related Art

Portable electronic devices, such as mobile phones, MP3 players and Personal Digital Assistants (PDAs), are often used by individuals on a personal basis. In other words, it is not uncommon for a person to carry a portable electronic device with them throughout their day. Often, these portable electronic devices store media data for use by their user. In the case of digital media players or PDAs, media data is typically downloaded from a host computer when the digital media player or PDA is connected to the host computer by way of a cable. In the event that a digital media player or PDA supports wireless communication, it is possible that the downloading of media data to the digital media player or PDA could be performed in a wireless manner. In the case of mobile phones, media data (such as songs or ring tones) are downloaded over the wireless communication network (i.e., cellular phone network).

However, as portable electronic devices become more versatile, more interactive and more pervasive, it is advantageous for portable electronic devices to acquire data from other portable electronic devices. Thus, there is need to facilitate wireless data acquisition by portable media devices.

### SUMMARY OF THE INVENTION

The invention pertains to improved methods, computer readable media and systems that facilitate data acquisition by mobile electronic devices. One aspect pertains to content acquisition between mobile electronic devices that are within range of a local wireless network. In one embodiment, when a first mobile electronic device and a second mobile electronic device are within range of a common local wireless network, the first mobile electronic device can upgrade (e.g., refresh) at least a portion of its stored content with more recent content that is available from the second mobile electronic device. Another aspect pertains to content acquisition by mobile electronic devices capable of communicating across a peer-to-peer wireless network. In one embodiment, when a first mobile electronic device and a second mobile electronic device are capable of communicating over a peer-to-peer wireless network, the first mobile electronic device can effectively make use of network accessibility that is available to the second mobile electronic device.

The invention can be implemented in numerous ways, including as a method, system, device, apparatus (including or computer readable medium). Several embodiments of the invention are discussed below.

As a method for obtaining digital content at a first mobile electronic device, one embodiment of the invention can, for example, include at least: discovering a second mobile electronic device that is wirelessly accessible to the first mobile electronic device; determining whether the second mobile electronic device is trusted; receiving information pertaining to shareable content available from the second electronic device; determining desired content for the first mobile electronic device from the shareable content available from the second mobile electronic device; and obtaining the desired content from the second mobile electronic device.

As a computer readable medium including at least executable computer program code tangibly stored thereon for obtaining digital data at a first mobile electronic device, one embodiment of the invention can, for example, include at least: computer program code for discovering a second mobile electronic device that is wirelessly accessible to the first mobile electronic device; computer program code for receiving information pertaining to shareable content available from the second electronic device; computer program code for determining desired content for the first mobile electronic device from the shareable content available from the second mobile electronic device; and computer program code for obtaining the desired content from the second mobile electronic device.

As a method for providing wireless access to remote content, one embodiment of the invention can, for example, include at least: discovering a surrogate mobile electronic device in the vicinity of a primary mobile electronic device; determining whether the surrogate mobile electronic device has network availability with respect to a network; determining whether the surrogate mobile electronic device permits the primary mobile electronic device to utilize at least a portion of its network bandwidth with respect to the network, if it is determined that the surrogate electronic device has network availability with respect to the network; requesting particular content from the network via the surrogate mobile electronic device, if it is determined that the surrogate mobile electronic device permits the primary mobile electronic device to utilize at least a portion of its network bandwidth with respect to the network; and receiving the particular content from the network at the primary mobile electronic device via the surrogate mobile electronic device.

As a computer readable medium including at least executable computer program code tangibly stored thereon for providing wireless access to remote content, one embodiment of the invention can, for example, include at least: computer program code for discovering a second mobile electronic device in the vicinity of a first mobile electronic device; computer program code for determining whether the second mobile electronic device has network availability with respect to a network; computer program code for determining whether the second mobile electronic device permits the first mobile electronic device to utilize at least a portion of its network bandwidth with respect to the network; computer program code for requesting particular content from the network via the second mobile electronic device; and computer program code for receiving the particular content from the network at the first mobile electronic device via the second mobile electronic device.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a block diagram of a wireless content delivery system according to one embodiment of the invention.

FIG. 2A illustrates the wireless content delivery system illustrated in FIG. 1 in accordance with a first content delivery scenario.

FIG. 2B illustrates the wireless content delivery system illustrated in FIG. 1 in accordance with a second content delivery scenario.

FIG. 2C illustrates the wireless content delivery system illustrated in FIG. 1 in accordance with a third content delivery scenario.

FIGS. 3A and 3B illustrate a data asset update arrangement according to one embodiment of the invention.

FIG. 4 illustrates a mesh arrangement of mobile media devices according to one embodiment of the invention.

FIG. 5 is a flow diagram of a content retrieval process according to one embodiment of the invention.

FIGS. 6A and 6B are flow diagrams of a content update process according to one embodiment of the invention.

FIG. 7 is a block diagram of a mobile multi-function device according to one embodiment of the invention.

### DETAILED DESCRIPTION OF THE INVENTION

The invention pertains to improved methods, computer readable media and systems that facilitate data acquisition by mobile electronic devices. One aspect pertains to content acquisition between mobile electronic devices that are within range of a local wireless network. In one embodiment, when a first mobile electronic device and a second mobile electronic device are within range of a common local wireless network, the first mobile electronic device can upgrade (e.g., refresh) at least a portion of its stored content with more recent content that is available from the second mobile electronic device. Another aspect pertains to content acquisition by mobile electronic devices capable of communicating across a peer-to-peer wireless network. In one embodiment, when a first mobile electronic device and a second mobile electronic device are capable of communicating over a peer-to-peer wireless network, the first mobile electronic device can effectively make use of network accessibility that is available to the second mobile electronic device.

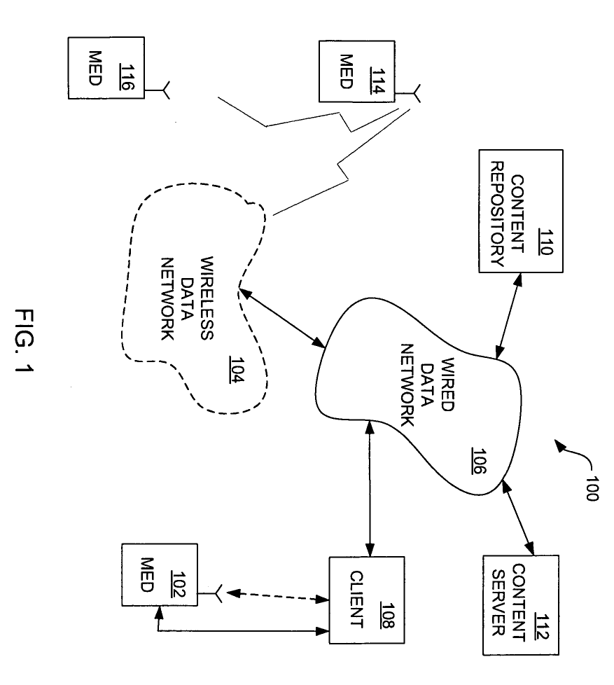

Embodiments of the invention are discussed below with reference to FIGS. 1-7. However, those skilled in the art will readily appreciate that the detailed description given herein with respect to these figures is for explanatory purposes as the invention extends beyond these limited embodiments.

FIG. 1 is a block diagram of a wireless content delivery system 100 according to one embodiment of the invention. The wireless content delivery system 100 allows content (i.e., digital data) to be transferred between different electronic devices so as to deliver content to one or more electronic devices.

The wireless content delivery system 100 can include a mobile electronic device 102. The mobile electronic device 102 is a mobile electronic device that has wireless capabilities. For example, the mobile electronic device 102 can be a mobile electronic device that supports at least wireless data transfer. As an example, the mobile electronic device 102 can be a personal media device having Bluetooth, 802.11 and/or other wireless capability.

The wireless content delivery system 100 can also include a wireless data network 104. Although the mobile electronic device 102 is mobile and therefore easily transported by its user, the mobile electronic device 102 will at times be able to wirelessly connect to the wireless data network 104. The wireless data network 104 can also be coupled to a wired data network 106. The wired data network 106 is typically a global network but could also be a local area network or a wide area network. One example of a global network is the Internet.

The wireless content delivery system 100 can also include a client 108 that is associated with the mobile electronic device 102. Typically, the client 108 and the mobile electronic device 102 can be associated by way of a common user. The client 108 is, for example, a computing device, such as a personal computer. In any case, the mobile electronic device 102 can connect with the client 108. In one implementation, the mobile electronic device 102 can physically connect with the client 108 by way of a cable or a dock. In another implementation, the mobile electronic device 102 can wirelessly connect to the client 108 such as via a short range wireless network (e.g., Bluetooth network). The client 108 can in turn be coupled to the wired data network 106.

When the mobile electronic device 102 is connected (wirelessly or wired) with the client 108, the mobile electronic device 102 can receive content from the client 108. Typically, the client 108 would have received (at that time or previously) such content from the wired data network 106.

The wireless content delivery system 100 can further include a content repository 110 and a content server 112. The content being provided to the mobile electronic device 102 can, for example, be provided from the content repository 110 or the content server 112. Although the content server 112 is illustrated in FIG. 1, the wireless content delivery system 100 typically includes a plurality of different content servers geographically distributed yet operatively connected to the wired data network 106. The content repository 110 can, in one embodiment, correspond to or be associated with an online store that sells, rents or otherwise distributes digital data assets, such as digital media items. The wireless content delivery system 100 may include a plurality of different content repositories geographically distributed yet operatively connected to the wired data network 106.

The wireless content delivery system 100 can also support other mobile electronic devices, such as mobile electronic device 114 and mobile electronic device 116 illustrated in FIG. 1. The mobile electronic device 114 can communicate with the wireless data network 104 when the mobile electronic device 114 is within range of the wireless data network 104. The mobile electronic device 114 can communicate with the mobile electronic device 102 via the wireless data network 104, or can communicate with either the content repository 110 or the content server 112 via the wireless data network 104 and the wired data network 106.

Still further, the mobile electronic device 116, in one embodiment, is capable of wirelessly communicating with the mobile electronic device 114 over a short range wireless network, such as a peer-to-peer wireless network. As such, the mobile electronic device 116 can receive data that is stored on, or otherwise unavailable to, the mobile electronic device 114. In one embodiment, the mobile electronic device 116 can receive data resident on the mobile electronic device 114 that is more current than corresponding data stored on the mobile electronic device 116. In another embodiment, the mobile electronic device 116 can interact with the mobile electronic device 114 to cause the mobile electronic device 114 to request certain data from a remote resource, such as the content repository 110 or the content server 112.

In one embodiment, one mobile device can discover another mobile device within its vicinity. The mobile devices can then wirelessly transfer data from one mobile device to the other. Typically, the mobile devices are associated with persons (users). The mobile devices, or their users, can control, request or influence the particular data content being delivered. The device or user control can be provided in real-time or in advance through use of settings, such as preferences. In one implementation, the mobile devices can act automatically without user input to transfer data from one mobile device to another. For example, a background process can operate to discover other mobile devices within its vicinity and to initiate data transfer as appropriate (e.g., as configured via preference settings).

In another embodiment, one mobile device can discover another mobile device having network availability within its vicinity. For example, the network availability can pertain to access to a global data network, such as the Internet. When the other device with network availability is discovered, the mobile device can wirelessly communicate with the other device so as make use of the network availability to request and receive content from the global data network via the other mobile device.

The content delivery described is particularly suited for delivery of content. In one embodiment, the content can be media data. “Media data,” as used herein, is digital data that pertains to at least one of audio, video, and images. Some examples of specific forms of media data (which can be referred to as “media items”) include, but are not limited to, songs, albums, audiobooks, playlists, movies, music videos, photos, computer games, podcasts, audio and/or video presentations. News, financial and/or sports data can also be considered media data. Media data is also referred to as media content herein.

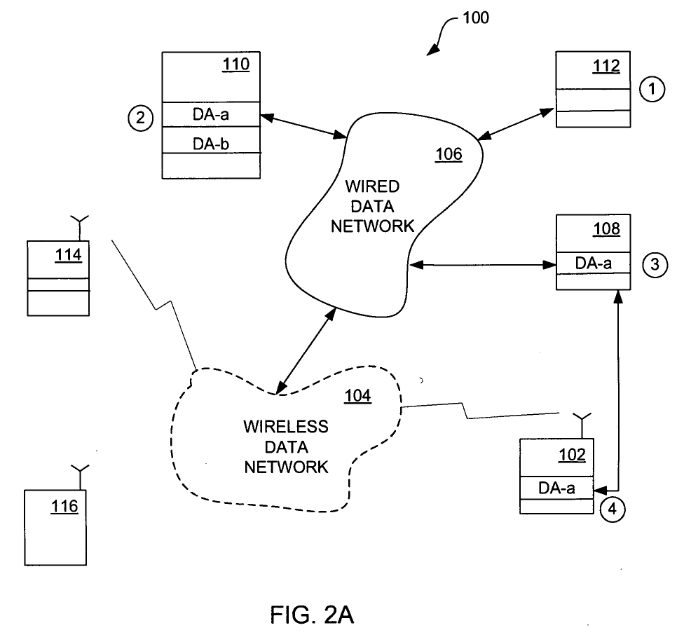

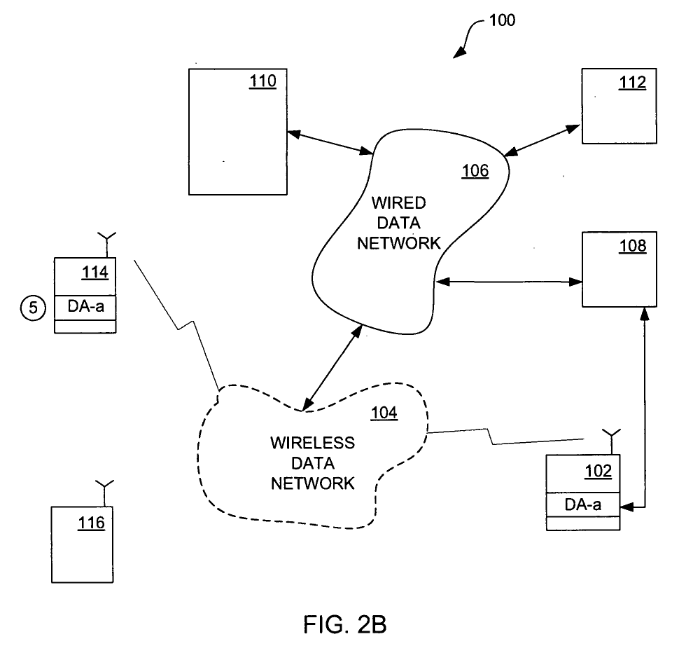

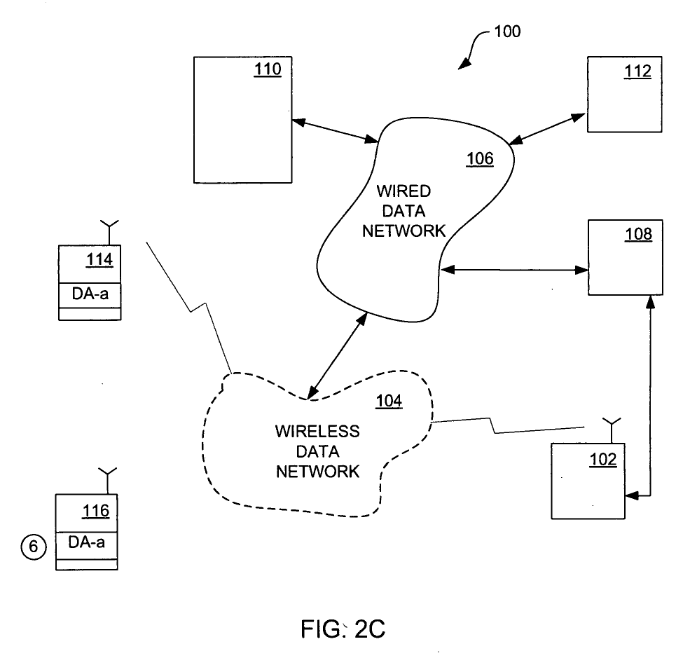

FIG. 2A illustrates the wireless content delivery system 100 illustrated in FIG. 1 in accordance with a first content delivery scenario. In the first content delivery scenario, it is assumed that a digital asset (DA-a) is a resident on the content server 112. The digital asset (DA-a) can be provided to the content repository 110 for further distribution, rental or sale. In this example, in the content repository 110 also stores a digital asset (DA-b). The client 108 and the mobile electronic device 102 are associated with a user that has an interest in the digital asset (DA-a). The user can express their interest in various digital assets through use of category selections, user profile, usage history, user preferences, etc. The client 108 can operate to interact with the content repository 110 via the wired data network 106 to receive the digital asset (DA-a). Then, when a connection is available between the client 108 and the mobile electronic device 102, the digital asset (DA-a) can be delivered from the client 108 to the mobile electronic device 102. In this example, the digital asset (DA-a) has migrated from the content repository 110 or the content server 112 to the mobile electronic device 102.

FIG. 2B illustrates the wireless content delivery system 100 illustrated in FIG. 1 in accordance with a second content delivery scenario. The second content delivery scenario can follow from the first content delivery scenario. In the second content delivery scenario, it is assumed that a digital asset (DA-a) is currently resident on the mobile electronic device 102. When the mobile electronic device 114 is within range of the wireless data network 104, the mobile electronic device 114 can operate to discover whether any other mobile electronic devices are accessible to the wireless data network 104. For example, when the mobile electronic device 102 is also within range of the wireless data network 104, the mobile electronic device 114 can discover the availability of the mobile electronic device 102. Thereafter, since the user associated with in the mobile electronic device 114 has an interest in the digital asset (DA-a), the digital asset (DA-a) can be delivered from the mobile electronic device 102 to the mobile electronic device 114 via the wireless data network 104. In this example, the digital asset (DA-a) has migrated from the content repository 110 or the content server 112 to the mobile electronic device 102. Here, it is assumed that the mobile electronic device 114 did not previously have the digital asset (DA-a) but subsequently can receive the digital asset (DA-a) from the mobile electronic device 102 via the wireless data network. However, in another variation of this content delivery scenario, the mobile electronic device 114 initially has an older version of the digital asset (DA-a), whereby the mobile electronic device can thus receive a newer version of the digital asset (DA-a) from the mobile electronic device 102 via the wireless data network.

FIG. 2C illustrates the wireless content delivery system 100 illustrated in FIG. 1 in accordance with a third content delivery scenario. The third content delivery scenario can follow from the second content delivery scenario. In the third content delivery scenario, it is assumed that a digital asset (DA-a) is currently resident on the mobile electronic device 114 (e.g., by way of the first content delivery scenario and the second content delivery scenario). In this embodiment, the mobile electronic device 116 may not be within range of the wireless data network 104. However, the mobile electronic device 116 may be in range of the mobile electronic device 114 so that a peer-to-peer wireless network (or peer-to-peer wireless connection) can be established. When the peer-to-peer network can be established between the mobile electronic device 116 and the mobile electronic device 114, the digital asset (DA-a) when deemed of interest to the user, can be delivered from the mobile electronic device 114 to the mobile electronic device 116. In this example, the digital asset (DA-a) has migrated from the mobile electronic device 114 to the mobile electronic device 116.

Hence, considering the first content delivery scenario together with the second content delivery scenario and the third content delivery scenario, a digital asset (DA-a) is able to migrate across various networks and through various devices in a controlled manner. Namely, it in this particular example, the digital asset (DA-a) has migrated from the content repository 110 or the content server 112 to the mobile electronic devices 102, 114 and 116.

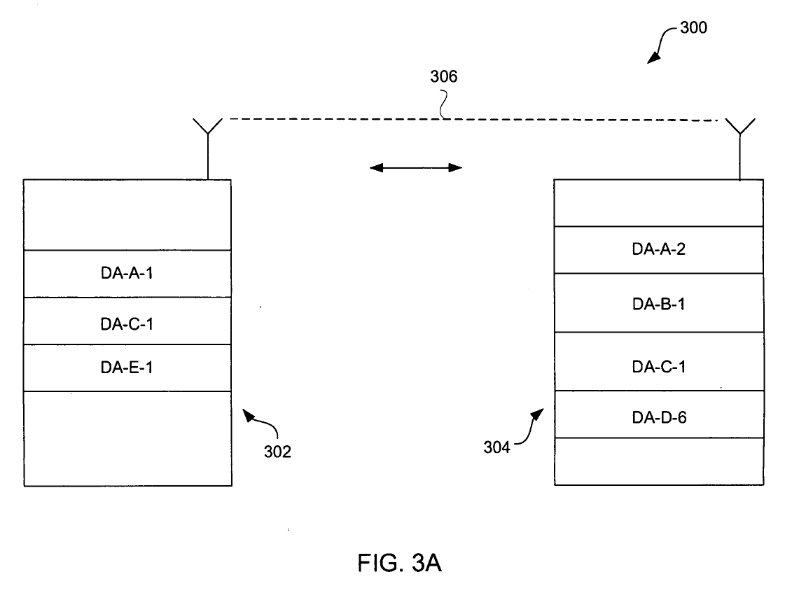

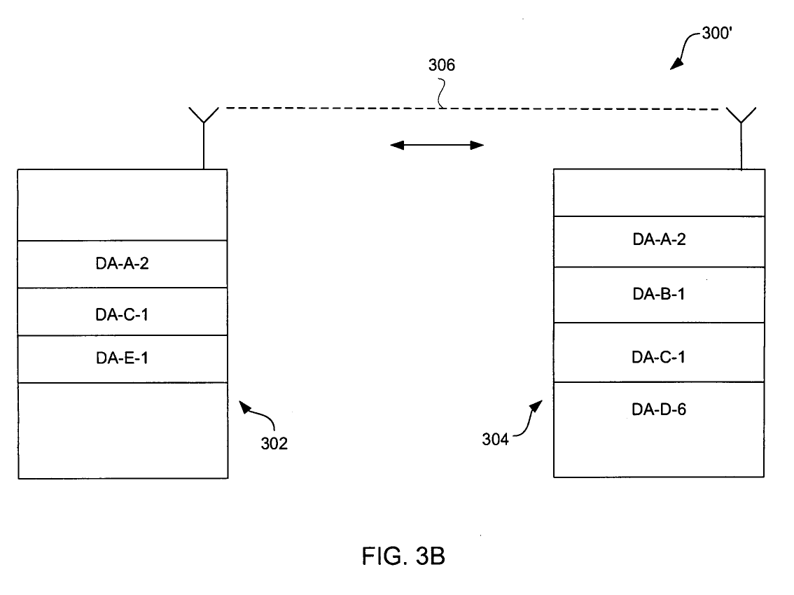

FIGS. 3A and 3B illustrate a data asset update arrangement according to one embodiment of the invention. FIG. 3A illustrates a data asset update arrangement 300 according to one exemplary implementation. The data asset update arrangement 300 concerns updating data assets on a mobile electronic device. More particularly, the data asset update arrangement 300 concerns exchange of data assets with respect to a mobile electronic device 302 and a mobile electronic asset device 304 that are wirelessly connected via a wireless link 306. For example, with reference to FIG. 1, the wireless link 306 can be established via the wireless data network 104 and/or a peer-to-peer wireless network. In the exemplary implementation illustrated in FIG. 3A, the mobile electronic device 302 initially stores a set of digital assets, namely, DA-A-1, DA-C-1 and DA-E-1; and the mobile electronic device 304 initially stores a set of digital assets, namely, DA-A-2, DA-B-1, DA-C-1 and DA-D-1. The digital assets can pertain to content, such as media data. When the wireless link 306 is present, the mobile electronic devices 302 and 304 can communicate with one another to determine whether each has any digital assets that the other is interested in. More particularly, in this particular example, the mobile electronic device 302 includes digital assets A, C and E, with each such digital asset being a first version. Also, in this particular example, the mobile electronic device 304 includes digital assets A, B, C and D, with digital assets B and C being first versions, digital asset A being a second version and digital asset D being a sixth version. Accordingly, the mobile electronic device 302 can communicate with the mobile electronic device 304 to determine that the mobile electronic device 304 has second version (i.e., a later version) of the digital asset A, whereas the mobile electronic device 302 has the first version of the digital asset A. Hence, the mobile electronic device 302 can receive the second version of these digital asset A from the mobile electronic device 304. The mobile electronic device 304, on the other hand, does not receive any versions of digital assets A or C from the mobile electronic device 302, since such digital assets are of the same version as is already stored thereon.

FIG. 3B illustrates a data asset update arrangement 300′ according to one exemplary implementation. The data asset update arrangement 300′ represents the data asset update arrangement 300 illustrated in FIG. 3A after the update for these digital asset A has been performed. Although not illustrated in FIG. 3B, updates to the digital assets can optionally also update the mobile electronic device 302 to include the sixth version of the digital asset D provided by the mobile electronic device 304. The updating with respect to the digital asset D can, for example, depend upon whether the user of the mobile electronic device 302 has an interest in the digital asset D. For example, if the user of the mobile electronic device 302 does not have an interest in a digital asset D, then the mobile electronic device 302 can decline to receive (or not request) the digital asset D. In addition, although not illustrated in FIG. 3B, updates to the digital assets can optionally also update the mobile electronic device 304 to include the first version of the digital asset E provided by the mobile electronic device 302. The updating with respect to the digital asset E can, for example, depend upon whether the user of the mobile electronic device 304 has an interest in the digital asset E. For example, if the user of the mobile electronic 304 device does not have an interest in a digital asset D, then the mobile electronic device 302 can decline to receive (or not request) the digital asset D.

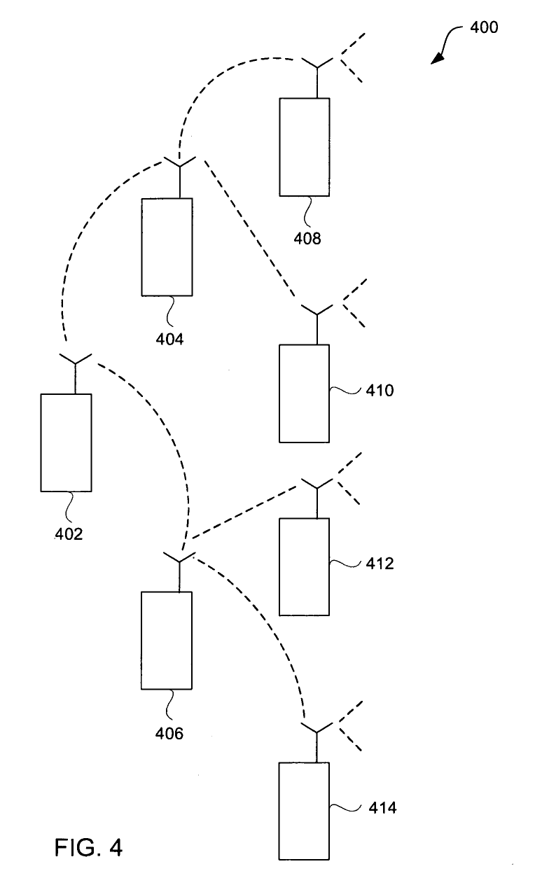

FIG. 4 illustrates a mesh arrangement 400 of mobile media devices according to one embodiment of the invention. The mesh arrangement 400 includes a base mobile electronic device 402 that can distribute digital data wirelessly to mobile electronic device 404 and mobile electronic device 406 by coming within vicinity of such devices. In turn, the mobile electronic device 404 can wirelessly distribute digital data to mobile electronic device 408 and mobile electronic device 410. Also, the mobile electronic device 406 can wirelessly distribute digital data to mobile electronic device 412 and mobile electronic device 414. The digital data can be the same digital data that is able to be distributed by the mesh arrangement 400 from one mobile electronic device to another mobile electronic device. In this manner, digital data can be distributed or delivered in a viral manner based on short range wireless connections that are available between mobile electronic devices. One advantage of such a distribution network of mobile electronic devices is that a particular mobile electronic device may not frequently (or even ever) connect to a global network to receive updated digital data, but instead could come within the vicinity of other mobile electronic devices who themselves, or some other device that they have come in contact with, have recently connected it to a global network. Another advantage of such a distribution network is that one mobile electronic device can unicast, broadcast or anycast certain content to one or more other mobile electronic devices that are within the vicinity. For example, a classified add or a party invitation can be wireless distributed (e.g., wireless viral distribution) from one initial mobile electronic device to many other mobile electronic devices just through data transfer between various mobile electronic devices as they become in vicinity of one another. As another example, an online media store might distribute a freely distributable media item (e.g., song), and after download to a mobile electronic device, the media item can be virally distributed to various other mobile electronic devices. Similarly, other types of data, such as news data, widget data, RSS feeds (e.g., podcasts), etc., can be distributed in a viral manner.

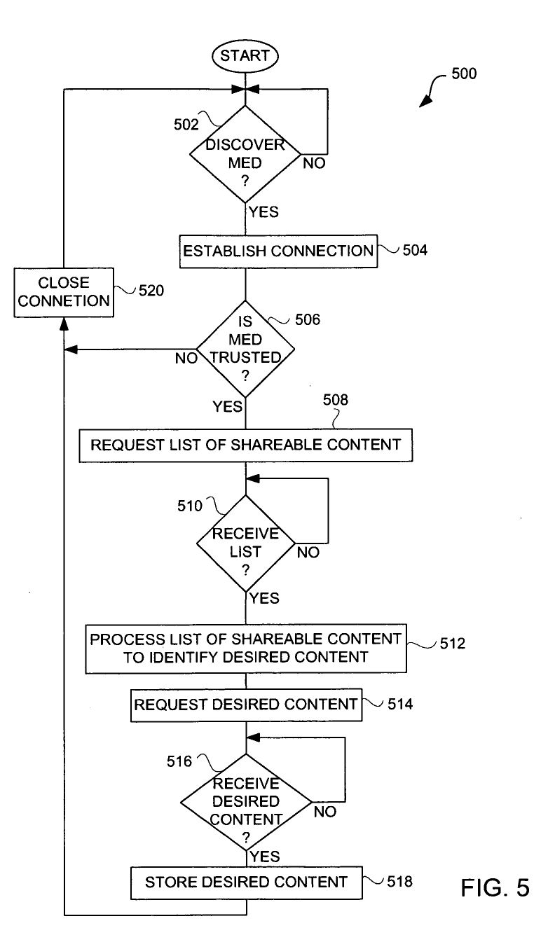

FIG. 5 is a flow diagram of a content retrieval process 500 according to one embodiment of the invention. The content retrieval process 500 can, for example, pertain to processing performed on a mobile electronic device (MED). The mobile electronic device performing the content retrieval process 500 can, for example, pertain to the mobile electronic device 114 illustrated in FIG. 1A. In general, the content retrieval process 500 can be initiated upon request of the user of the mobile electronic device or performed automatically by the mobile electronic device itself (e.g., such as in a background mode).

The content retrieval process 500 can begin with a decision 502 that determines whether another mobile electronic device has been discovered. Here, in the mobile electronic device performing the content retrieval process 500 can operate to discover other mobile electronic devices within its general vicinity. For example, using wireless technologies, the mobile electronic device performing the content retrieval process 500 can periodically attempt to locate other mobile electronic devices within its vicinity which it might wirelessly communicate with. When the decision 502 determines that a mobile electronic device has not been discovered, the content retrieval process 500 can wait until a mobile electronic device is discovered.

On the other hand, when the decision 502 determines that a mobile electronic device has been discovered, a connection can be established 504 between the mobile electronic device performing the content retrieval process 500 and the discovered mobile electronic device. Next, a decision 506 can determine whether the discovered mobile electronic device is trusted. When the decision 506 determines that the discovered mobile electronic device is not trusted, then the connection between the two devices can be closed 522 and the content retrieval process 500 re-started. In this case, since many discovered mobile electronic device are likely not trusted, content is not retrieved from such discovered mobile electronic devices because such content may be unreliable or damaging.

Alternatively, when the decision 506 determines that the discovered mobile electronic device is trusted, a list of shareable content can be requested 508. Here, the mobile electronic device performing the content retrieval process 500 can request 508 the list of shareable content from the discovered mobile electronic device. In one embodiment, the discovered mobile electronic device maintains a list or other data structure that identifies content available to be shared with a requesting mobile electronic device. After the list of shareable content has been requested 508, a decision 510 can determine whether the list of sharable content has been received. Here, the decision 510 determines whether the list of shareable content has been received from the discovered mobile electronic device. When the decision 510 determines that the list of shareable content has not yet been received, then the content retrieval process 500 awaits receipt of the list of shareable content.

Once the decision 510 determines that the requested list of shareable content has been received, the list of shareable content can be processed 512 to identify desired content. The desired content is content of interest to a user of the mobile electronic device. The user of the mobile electronic device can, for example, express their interest in content (digital assets) through use of category selections, user profile, usage history, user preferences, etc. The desired content can also be updated content that is more current (i.e., fresher) than corresponding content resident on the mobile electronic device.

After the list of shareable content is processed 512 to identify desired content, desired content can be requested 514. Here, the desired content represents some or all of the shareable content that was identified in the list of shareable content. Once the desired content is requested 514, a decision 516 can determine whether the desired content has been received. When the decision 516 determines that the desired content has not yet been received, the content retrieval process 500 can await receipt of the desired content. Once the decision 516 determines that the desired content has been received, the desired content can be stored 518. Thereafter, the content retrieval process 500 can closes 520 the connection between the mobile electronic device performing the content retrieval process 500 and the discovered mobile electronic device. After the connection has been closed 520, the content retrieval process 500 can return to repeat the decision 502 and subsequent blocks so that content retrieval can again be performed between different mobile electronic devices. To the extent that a mobile electronic device receives desired content from various different mobile electronic devices, the mobile electronic device can aggregate the desired data it receives from the various different mobile electronic devices.

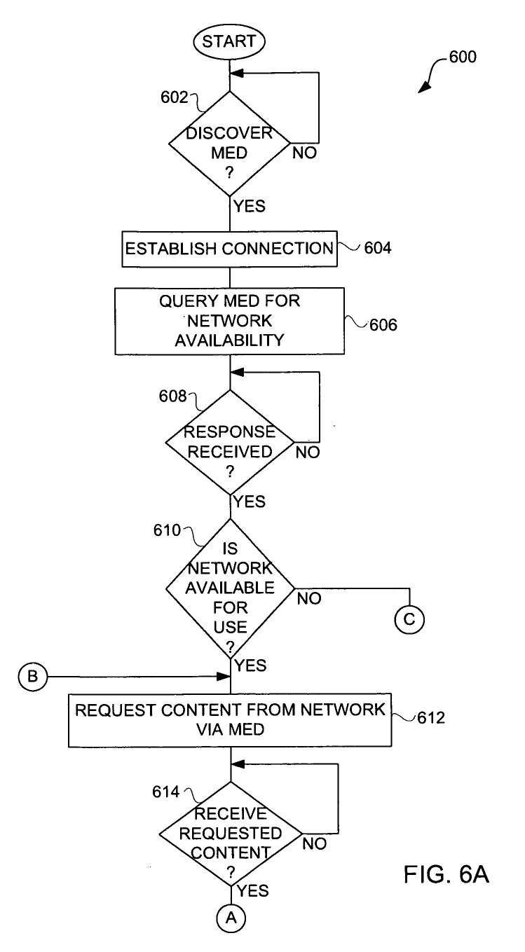

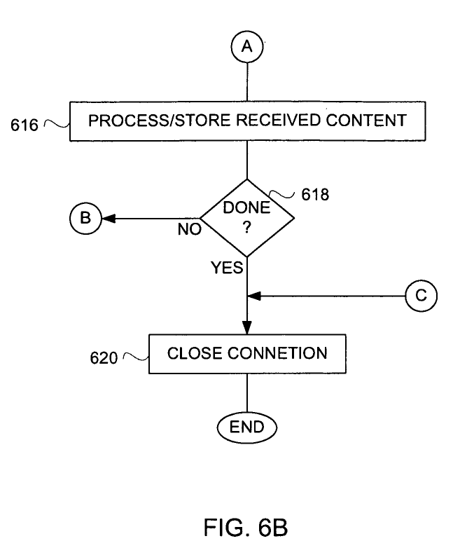

FIGS. 6A and 6B are flow diagrams of a content update process 600 according to one embodiment of the invention. The content update process 600 is, for example, performed by a mobile electronic device, such as the mobile electronic device 116 illustrated in FIG. 1. In general, the content update process 600 can be initiated upon request of a user of the mobile electronic device or performed automatically by the mobile electronic device itself (e.g., such as in a background mode).

The content update process 600 can begin with a decision 602 that determines whether another mobile electronic device has been discovered. When the decision 602 determines that another mobile electronic device has not been discovered, the content update process 600 can wait until a mobile electronic device has been discovered.

When the decision 602 determines that another mobile electronic device has been discovered, a connection can be established 604 between the mobile electronic device performing the content update process 600 and the discovered mobile electronic device. The discovered mobile electronic device can then be queried 606 for network availability. Here, the mobile electronic device performing the content update process 600 can query 606 the discovered mobile electronic device for information regarding any networks that might be available to the discovered mobile electronic device. In one implementation, the network of interest is a localized wireless network (e.g., 802.11 network). Next, a decision 608 can determine whether a response to the query has been received. When the decision 608 determines that a response has not yet been received, the content update process 600 can await such a response.

On the other hand, once the decision 608 determines that a response to the query has been received, a decision 610 can determine whether network capacity at the discovered mobile electronic device is available for use. In one embodiment, the mobile electronic device performing in the content update process 600 can operate to determine whether the discovered mobile electronic device has network availability that can be at least partially utilized for the benefit of the mobile electronic device performing the content update process 600. For example, if the discovered mobile electronic device has access to a global data network (e.g., the Internet), the mobile electronic device performing the content update process 600 may desire to utilize a least a portion of this available network capacity so long as permitted by the discovered mobile electronic device. The discovered mobile electronic device can, for example, access a global data network by way of a wireless network (e.g., such as provided at a wireless hotspot). Hence, when the decision 610 determines that the discovered mobile electronic device has network availability that is permitted to be utilized by the mobile electronic device performing the content update process 600, then the content update process 600 can request 612 content from the available network via the discovered mobile electronic device. In one implementation, the request 612 for content can be performed on an automatic basis, such as by a background process. In another implementation, and the request for content can be performed at the behest of a user on a manual basis, such as through use of graphical user interface controls.

After the content has been requested 612, a decision 614 can determine whether the requested content has been received. When the decision 614 determines that the requested content has not yet been received, the content update process 600 can await receipt of the requested content. Alternatively, when the decision 614 determines that the requested content has been received, the content update process 600 can continue. When the content update process 600 continues, the received content can be processed and/or stored 616 at the mobile electronic device performing the content update process 600.

Next, a decision 618 can determine whether the content update process 600 is done. For example, when all of the received content has been processed and/or stored 616, the mobile electronic device performing the content update process 600 has been updated. The updating may require a plurality of different requests for content. Hence, when the decision 618 determines that the content update process 600 is not done, the content update process 600 can return to repeat the block 612 so that an additional request for content can be performed. On the other hand, when the decision 618 determines that the content update process 600 is done, the connection between the mobile electronic device performing the content update process 600 and the discovered mobile electronic device can be closed 620. Additionally, when the decision 610 determines that the discovered mobile electronic device does not have any network availability that is permitted to be utilized by the mobile electronic device performing the content update process 600, then the content update process 600 can proceed to close 620 the connection. Following the block 620, the content update process 600 can end.

Additional information on wireless data sharing, exchange, transfer or delivery for portable electronic devices, see U.S. Patent Publication No. 20070161402 and U.S. Patent Publication No. 20070155307, of which both hereby incorporated herein by reference.

Mobile media devices can also be referred to as portable media devices. Portable media devices can, for example, be portable digital media players (e.g., MP3 players) or other portable multi-function devices (e.g., mobile telephones or Personal Digital Assistants). Portable media devices, such as portable media players or other portable multi-function devices, can also be small and highly portable and have limited processing resources. Often, portable devices are hand-held devices, such as hand-held media players or hand-held multi-function devices, which can be easily held by and within a single hand of a user. Portable devices can also be pocket-sized, miniaturized or wearable.

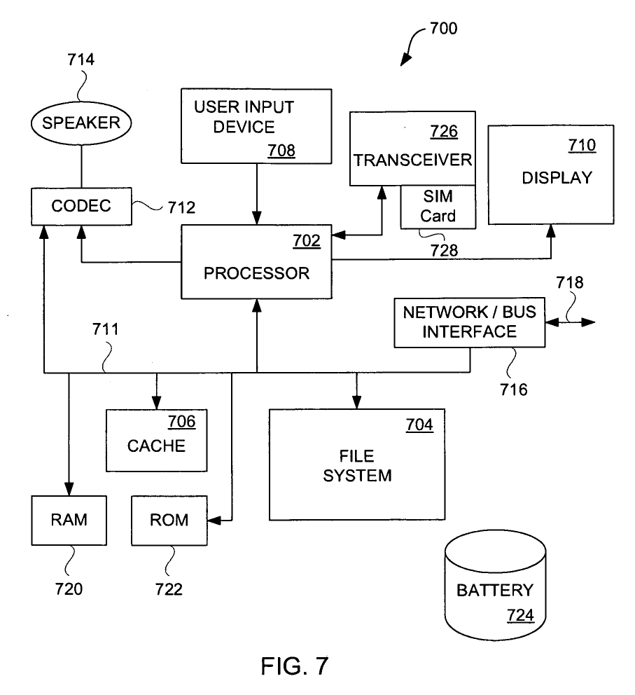

FIG. 7 is a block diagram of a mobile multi-function device 700 according to one embodiment of the invention. The mobile multi-function device 700 can, for example, include the circuitry of one or more of the mobile electronic devices 102, 114 or 116 illustrated in FIG. 1. The mobile multi-function device 700 includes hardware and software components to provide at least two functions, namely, a media playback function and a wireless voice communications function. When providing media playback, the mobile multi-function device 700 can operate as a media player capable of playing (including displaying) media items. The media items can, for example, pertain to audio items (e.g., audio files or songs), videos (e.g., movies) or images (e.g., photos), as different types of media assets. Media assets can also include any combinations of these different type of media assets with other data. When providing wireless voice communications, the mobile multi-function device 700 can operate a mobile telephone (e.g., cellular phone).

The mobile multi-function device 700 includes a processor 702 that pertains to a microprocessor or controller for controlling the overall operation of the mobile multi-function device 700. The mobile multi-function device 700 stores media data pertaining to media items in a file system 704 and a cache 706. In one embodiment, the file system 704 is implemented by a storage disk or a plurality of disks. In another embodiment, the file system 704 is implemented by EEPROM or Flash type memory. The file system 704 typically provides high capacity storage capability for the mobile multi-function device 700. However, since the access time to the file system 704 is relatively slow, the mobile multi-function device 700 can also include a cache 706. The cache 706 is, for example, Random-Access Memory (RAM) provided by semiconductor memory. The relative access time to the cache 706 is substantially shorter than for the file system 704. However, the cache 706 does not have the large storage capacity of the file system 704. Further, the file system 704, when active, consumes more power than does the cache 706. The power consumption is often a concern when the mobile multi-function device 700 is a portable mobile multi-function device that is powered by a battery (not shown). The mobile multi-function device 700 also includes a RAM 720 and a Read-Only Memory (ROM) 722. The ROM 722 can store programs, utilities or processes to be executed in a non-volatile manner. The ROM 722 can be implemented by an EEPROM or Flash type memory so as to provide writable non-volatile data storage. The RAM 720 provides volatile data storage, such as for the cache 706.

To support wireless voice communications, the mobile multi-function device 700 includes a transceiver 726. The transceiver 726 supports wireless communication with a wireless network (such as a wireless cellular network). To support certain wireless networks, such as a GSM network, the multi-function device 700 can also include a SIM card 728. The SIM card 728 includes an identifier (e.g., SIM identifier) can be used by the mobile multi-function device 700 to gain access and utilize the wireless network.

The mobile multi-function device 700 also includes a user input device 708 that allows a user of the mobile multi-function device 700 to interact with the mobile multi-function device 700. For example, the user input device 708 can take a variety of forms, such as a button, keypad, dial, etc. Still further, the mobile multi-function device 700 includes a display 710 (screen display) that can be controlled by the processor 702 to display information to the user. A data bus 711 can facilitate data transfer between at least the file system 704, the cache 706, the processor 702, and the CODEC 712.

In one embodiment, the mobile multi-function device 700 serves to store a plurality of media items (e.g., songs) in the file system 704. When a user desires to have the mobile multi-function device play a particular media item, a list of available media items is displayed on the display 710. Then, using the user input device 708, a user can select one of the available media items. The processor 702, upon receiving a selection of a particular media item, supplies the media data (e.g., audio file) for the particular media item to a coder/decoder (CODEC) 712. The CODEC 712 then produces analog output signals for a speaker 714. The speaker 714 can be a speaker internal to the mobile multi-function device 700 or external to the mobile multi-function device 700. For example, headphones or earphones that connect to the mobile multi-function device 700 would be considered an external speaker.

The mobile multi-function device 700 also includes a bus interface 716 that couples to a data link 718. The data link 718 allows the mobile multi-function device 700 to couple to a host device (e.g., host computer or power source). The data link 718 can also provide power to the mobile multi-function device 700.

The mobile multi-function device 700 illustrated in FIG. 7 represents only one embodiment of a mobile device suitable for use with the invention. Other embodiments can be significantly different. For example, other embodiments need not provide a wireless voice communications function.

The various aspects, embodiments, implementations or features of the invention can be used separately or in any combination.

The invention is preferably implemented by software, hardware, or a combination of hardware and software. The invention can also be embodied as computer readable code on a computer readable medium. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

The advantages of the invention are numerous. Different aspects, embodiments or implementations may, but need not, yield one or more of the following advantages. One advantage of certain embodiment of the invention is that users of mobile electronic devices can perceive their devices as being persistently connected to a network, even though the devices may only occasionally connected to the network (e.g., the Internet). Another advantage is that digital data can be transmitted between mobile electronic devices (e.g., trusted mobile electronic devices) so as to update content on mobile electronic devices using updated content available from other mobile electronic devices. Yet another advantage of the invention is that one mobile electronic device can make use of network availability of another mobile electronic device.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method for obtaining digital content at a first mobile electronic device, said method comprising:
discovering a second mobile electronic device that is wirelessly accessible to the first mobile electronic device;
determining whether the second mobile electronic device is trusted;
receiving information pertaining to shareable content available from the second electronic device;
determining desired content for the first mobile electronic device from the shareable content available from the second mobile electronic device; and
obtaining the desired content from the second mobile electronic device.

2. A method as recited in claim 1, wherein said method further comprises:
establishing, after said discovering, a wireless connection between the first mobile electronic device and the second mobile electronic device.

3. A method as recited in claim 2, wherein said obtaining comprises:
receiving the desired content at the first mobile electronic device from the second mobile electronic device via the wireless connection.

4. A method as recited in claim 3, wherein said obtaining comprises:
storing the received desired content at the first mobile electronic device.

5. A method as recited in claim 1, wherein said obtaining comprises:
requesting the desired content from the second mobile electronic device;
receiving the desired content at the first mobile electronic device from the second mobile electronic device via the wireless connection; and
storing the received desired content at the first mobile electronic device.

6. A method as recited in claim 1, wherein the received information pertaining to shareable content available from the second electronic device comprises a list of available shareable content.

7. A method as recited in claim 6, wherein said determining of the desired content comprises:
processing the list of available shareable content to determine the desired content.

8. A method as recited in claim 7, wherein the desired content is content of interest to a user of the first mobile electronic device.

9. A method as recited in claim 7, wherein the desired content is updated content that is more current than corresponding content resident on the first mobile electronic device.

10. A computer readable medium including at least executable computer program code tangibly stored thereon for obtaining digital data at a first mobile electronic device, said computer readable medium comprising:
computer program code for discovering a second mobile electronic device that is wirelessly accessible to the first mobile electronic device;
computer program code for receiving information pertaining to shareable content available from the second electronic device;
computer program code for determining desired content for the first mobile electronic device from the shareable content available from the second mobile electronic device; and
computer program code for obtaining the desired content from the second mobile electronic device.

11. A computer readable medium as recited in claim 10, wherein said computer readable medium comprises:
computer program code for determining whether the second mobile electronic device is trusted.

12. A computer readable medium as recited in claim 11, wherein the second mobile electronic device is deemed trusted if the second mobile electronic device has a cryptographic key that authenticates the second electronic device.

13. A computer readable medium as recited in claim 10, wherein the desired content is updated content that is more current than corresponding content resident on the first mobile electronic device.

14. A method for providing wireless access to remote content, said method comprising:
(a) discovering a surrogate mobile electronic device in the vicinity of a primary mobile electronic device;
(b) determining whether the surrogate mobile electronic device has network availability with respect to a network;
(c) determining, if said determining (b) determines that the surrogate electronic device has network availability with respect to the network, whether the surrogate mobile electronic device permits the primary mobile electronic device to utilize at least a portion of its network bandwidth with respect to the network;
(d) requesting, if said determining (c) determines that the surrogate mobile electronic device permits the primary mobile electronic device to utilize at least a portion of its network bandwidth with respect to the network, particular content from the network via the surrogate mobile electronic device; and
(e) receiving the particular content from the network at the primary mobile electronic device via the surrogate mobile electronic device.

15. A method as recited in claim 14, wherein said method comprises:
establishing, after said discovering (a) and prior to said determining (c), a wireless connection between the primary mobile electronic device and the surrogate mobile electronic device,
wherein said determining (c), requesting (d) and receiving (e) are performed using the wireless connection.

16. A method as recited in claim 15, wherein said method comprises:
storing the received particular content at the primary mobile electronic device.

17. A method as recited in claim 15, wherein said method comprises:
subsequently closing the wireless connection.

18. A method as recited in claim 15, wherein the wireless connection is a direct wireless connection between the primary mobile electronic device and the surrogate mobile electronic device.

19. A computer readable medium including at least executable computer program code tangibly stored thereon for providing wireless access to remote content, said computer readable medium comprising:
computer program code for discovering a second mobile electronic device in the vicinity of a first mobile electronic device;
computer program code for determining whether the second mobile electronic device has network availability with respect to a network;
computer program code for determining whether the second mobile electronic device permits the first mobile electronic device to utilize at least a portion of its network bandwidth with respect to the network, if said computer program code for determining determines that the second electronic device has network availability with respect to the network;
computer program code for requesting particular content from the network via the second mobile electronic device, if said computer program code for determining determines that the second mobile electronic device permits the first mobile electronic device to utilize at least a portion of its network bandwidth with respect to the network; and
computer program code for receiving the particular content from the network at the first mobile electronic device via the second mobile electronic device.

20. A method as recited in claim 19, wherein said method comprises:
establishing a wireless connection between the first mobile electronic device and the second mobile electronic device,
wherein the wireless connection is a connection over a peer-to-peer network between the first mobile electronic device and the second mobile electronic device.
